(19) United States
(12) Patent Application Publication
(10) Pub. No.: US 2010/0005007 A1
(43) Pub. Date: Jan. 7, 2010

(54) METHODS OF ASSOCIATING REAL WORLD ITEMS WITH VIRTUAL WORLD REPRESENTATIONS

(76) Inventors: Aaron Roger Cox, Tucson, AZ (US); Brad Matthew Johnson, Raleigh, NC (US); Mary Sumner Johnson, Raleigh, NC (US)

Correspondence Address: ZILKA-KOTAB, PC- IBM, P.O. BOX 721120, SAN JOSE, CA, 95172-1120, US

(21) Appl. No.: 12/168,709

(22) Filed: Jul. 7, 2008

(51) Int. Cl. G06Q 30/00

(52) U.S. Cl. 705/27; 705/26

(57) ABSTRACT

A method according to one embodiment includes providing access to a representation of a real world item to an avatar in a virtual world based on a real world transaction involving a user associated with the avatar. A method according to another embodiment includes receiving notice that a user has purchased a real world item; providing access to a representation of the real world item to an avatar in a virtual world; and allowing the avatar to interact with the representation of the real world item in the virtual world; outputting. A method according to yet another embodiment includes providing an item to an avatar in a virtual world based on a real world transaction involving a user associated with the avatar. A method in a further embodiment includes providing a representation of a real world item to an avatar in a virtual world based on a real world transaction involving a user, wherein the user is not associated with the avatar.

### BACKGROUND

The present invention relates to virtual worlds, and more particularly, this invention relates to representations of real world items in virtual worlds.

Virtual worlds are growing in popularity and becoming new forms of social and economic environments. Virtual world objects (such as clothing, automobiles, electronics, etc.) add depth and quality to the on-line user experience and currently must be either built or purchased in the online world. Although likely desirable by many users, there is no automatic relation of a user's real world possessions to the objects they own in a virtual world.

### SUMMARY

A method according to one embodiment includes providing access to a representation of a real world item to an avatar in a virtual world based on a real world transaction involving a user associated with the avatar.

A method according to another embodiment includes receiving notice that a user has purchased a real world item; providing access to a representation of the real world item to an avatar in a virtual world; and allowing the avatar to interact with the representation of the real world item in the virtual world; outputting.

A method according to yet another embodiment includes providing an item to an avatar in a virtual world based on a real world transaction involving a user associated with the avatar.

A method in a further embodiment includes providing a representation of a real world item to an avatar in a virtual world based on a real world transaction involving a user, wherein the user is not associated with the avatar.

Any of these embodiments may be implemented in a computer system, which may include one or more computers, computer networks, user interfaces, etc.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a flow diagram of a method according to one embodiment.

FIG. 2 is a flow diagram of a method according to one embodiment.

FIG. 3 is a flow diagram of a method according to one embodiment.

FIG. 4 is a flow diagram of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In one general embodiment, a method comprises providing access to a representation of a real world item to an avatar in a virtual world based on a real world transaction involving a user associated with the avatar.

In another general embodiment, a method comprises receiving notice that a user has purchased a real world item; providing access to a representation of the real world item to an avatar in a virtual world; allowing the avatar to interact with the representation of the real world item in the virtual world; and outputting.

In another general embodiment, a method comprises providing an item to an avatar in a virtual world based on a real world transaction involving a user associated with the avatar.

In another general embodiment, a method comprises providing a representation of a real world item to an avatar in a virtual world based on a real world transaction involving a user, wherein the user is not associated with the avatar.

Some examples of virtual worlds which might be used with this invention include EVERQUEST® II, WORLD OF WARCRAFT®, THE SIMS 2™, etc. When something is defined as being from the real world, it indicates that the item is a tangible object accessible outside of a virtual world. When something is defined as being from a virtual world, it indicates that the item is not real or tangible in the real world, and only exists in one or more virtual worlds.

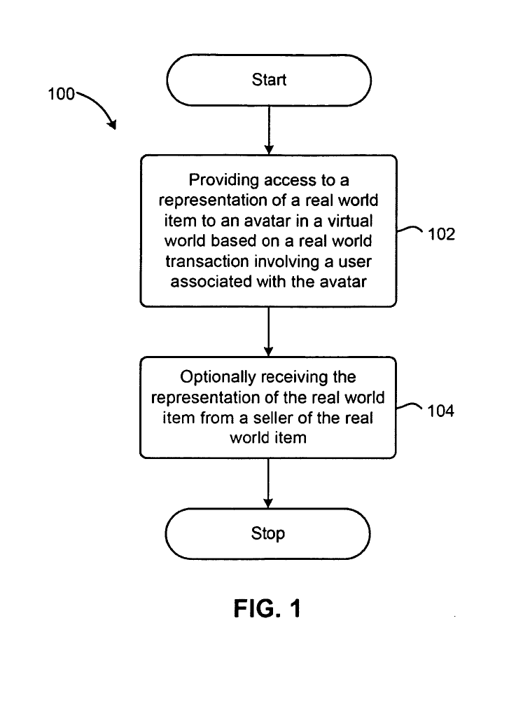

FIG. 1 illustrates a flow chart of a method 100 according to one embodiment. As an option, the present method 100 may be implemented in the context and functionality of a computer or computer system. Of course, the method 100 may be carried out in any desired environment. It should be noted that the aforementioned definitions may apply during the present description.

With continued reference to FIG. 1, in operation 102, access to a representation of a real world item is provided to an avatar in a virtual world based on a real world transaction involving a user associated with the avatar. The user and avatar may be associated in any way. For example, the user and avatar may be preassociated based on a registration, an account setting, etc. In other approaches, the avatar may become associated with the user upon some event such as occurrence of the real world transaction, account registration, etc.

In optional operation 104, the representation of the real world item may be received from a seller of the real world item. This seller may be anyone who sold the real item to the user, i.e., the manufacturer of the real item, a distributor of the real item, a retailer of the real item, etc., or another party who may not sell the item but is associated with the seller who does sell the item, such as marketing or advertising companies, promotional companies, companies running a promotion, a host or provider of the virtual world or portion thereof, etc.

In one embodiment, the real world transaction may be a retail purchase of the real world item, wherein a retail purchase may be an online purchase, an in person purchase from a storefront, etc. Accordingly, the representation may be of the actual real world item purchased in the retail purchase.

In a further embodiment, a receipt of the retail purchase may include a code for accessing the representation of the real world item in the virtual world, and may further comprise receiving the code from the user. The receipt may be a paper receipt, or an electronic receipt sent via email, accessible online, written to magnetic media such as CD-ROM, flash drive, etc. A code may be any sequence of numbers, letters, spaces, symbols, characters, words, bits, etc., and any combinations thereof. For example, an online retailer may send an email to the purchaser of an item which includes a code comprised of a sequence of letters and numbers which, when the purchaser enters this code into the retailer's website, sends the purchaser a virtual representation of the item previously purchased saved as an attachment to an email. The previous example in meant to clarify the embodiment, and in no way should limit the electronic receipt delivery methods or code formation and functionality.

In yet another embodiment of method 100, the avatar may act as a virtual shopping assistant to the user. For example, the user may “try out” the virtual representation of a real world item on the user's avatar Lo determine if the user actually wants to purchase the real item.

In another approach, the real world transaction may be a retail purchase of a real world item, wherein the representation is of another real world item having a predefined association with the purchased item, e.g., the representation may be of a pair of earrings, a pair of shoes, a belt, etc., that match a skirt that the user just purchased at a store. In this approach, the store may be able to “tie” associated items to the item already purchased in hopes that the user will like how the associated items look in the virtual world and make another real world purchase of the represented items.

In another embodiment of method 100, the real world transaction may be receipt of a code by a portable electronic device, such as a mobile phone, a cell phone, a pocket PC, a personal digital assistant (PDA), etc., the code being associated with the representation of the real world item.

In yet another embodiment of method 100, access to the representation of the real world item in the virtual world may be provided for a fee, surcharge, add-on cost, etc. In another approach, access to the representation of the real world item in the virtual world may expire after a predetermined amount of time. This pre-determined expiration time may also be removable if the user performs some activity, such as paying a fee. This may give the user a chance to determine whether they consider the representation worth the fee, whether the user feels the representation works in the virtual world as the user desires it to work, etc.

In another embodiment of method 100, the real world transaction may be receipt of a request from the user to access the representation of the real world item. For example, the transaction may comprise a request from the user to download the virtual world representation, and receipt of such request by the virtual world representation holder, such that the user may gain access to the virtual world representation.

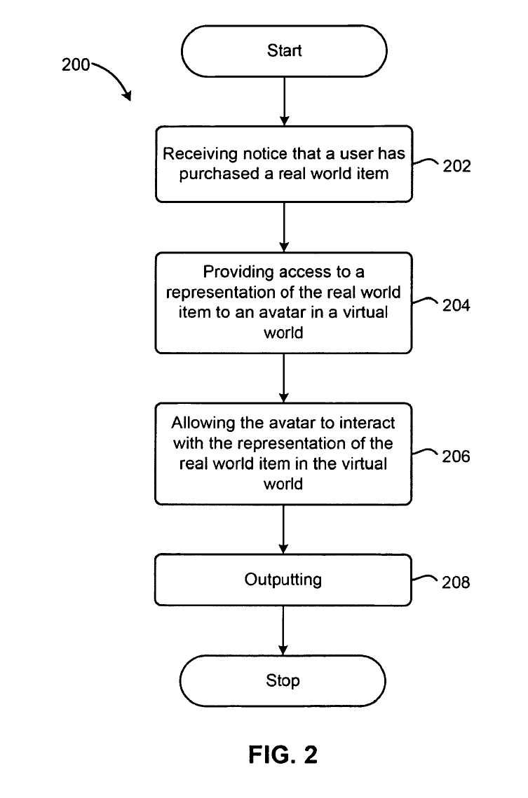

FIG. 2 illustrates a flow chart of a method 200 according to one embodiment. As an option, the present method 200 may be implemented in the context and functionality of a computer or computer system. Of course, the method 200 may be carried out in any desired environment. It should be noted that the aforementioned definitions may apply during the present description.

With continued reference to FIG. 2, in operation 202, notice that a user has purchased a real world item is received. For example, a retailer may track purchases made by customers and as each customer makes a purchase, an entry is made in a database denoting what was purchased in the transaction.

In operation 204, access to a representation of the real world item is provided to an avatar in a virtual world.

In a further embodiment of method 200, the representation may be of another real world item having a predefined association with the purchased item, e.g., the representation may be of a pair of earrings, a pair of shoes, a belt, etc., that match a skirt that the user just purchased at a store. In this approach, the store may be able to “tie” associated items to the item already purchased in hopes that the user will like how the associated items look in the virtual world and make another real world purchase of the represented items.

In other embodiments, the associated item may not exist in the real world or the associated item may exist in the real world and may be for sale by the seller of the real world item purchased by the user.

In operation 206, the avatar is allowed to interact with the representation of the real world item in the virtual world. This interaction may be directed by the user, or may occur according to a predetermined set of instructions for the representation.

In operation 208, something is output to the user. For example, the avatar and the representation of the real world item may be output to the user.

In a further embodiment, a receipt of the retail purchase may include a code for accessing the representation of the real world item in the virtual world, and may further comprise receiving the code from the user. The receipt may be a paper receipt, or an electronic receipt sent via email, accessible online, written to magnetic media such as CD-ROM, flash drive, etc. A code may be any sequence of numbers, letters, spaces, symbols, characters, words, etc., and any combinations thereof. For example, an online retailer may send an email to the purchaser of an item which includes a code comprised of a sequence of letters and numbers which, when the purchaser enters this code into the retailer's website, sends the purchaser a virtual representation of the item previously purchased saved as an attachment to an email. The previous example in meant to clarify the embodiment, and in no way should limit the electronic receipt delivery methods or code formation and functionality.

In another embodiment, the method 200 may further comprise receiving the representation of the real world item from a seller of the real world item. This seller may be anyone who sold the real item to the user, i.e., the manufacturer of the real item, a distributor of the real item, a retailer of the real item, etc., or another party who may not sell the item but is associated with the seller who does sell the item, such as marketing or advertising companies, promotional companies, companies running a promotion, a host or provider of the virtual world or portion thereof, etc.

In yet another embodiment of method 200, the avatar may act as a virtual shopping assistant to the user. For example, the user may “try out” the virtual representation of a real world item, such as clothing or shoes, on the user's avatar in the virtual world to determine if the user wants to purchase the real item in the real world.

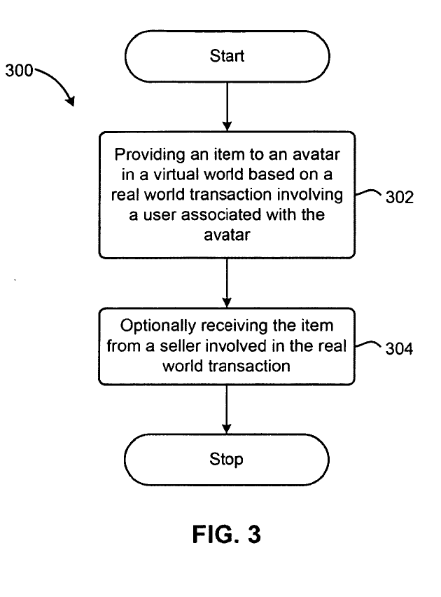

FIG. 3 illustrates a flow chart of a method 300 according to one embodiment. As an option, the present method 300 may be implemented in the context and functionality of a computer or computer system. Of course, the method 300 may be carried out in any desired environment. It should be noted that the aforementioned definitions may apply during the present description.

With continued reference to FIG. 3, in operation 302, an item is provided to an avatar in a virtual world based on a real world transaction involving a user associated with the avatar. After the item is received by the user, the avatar and the representation of the real world item may be output to the user.

In optional operation 304, the item may be received from a seller involved in the real world transaction. Of course, the item may also come from some other source besides the seller of the item in the real world transaction.

In another embodiment, the item may not exist in the real world. For example, if a user buys tickets to see a movie in the theaters, a representation of a T-shirt displaying the movie logo may be provided to the avatar in the virtual world.

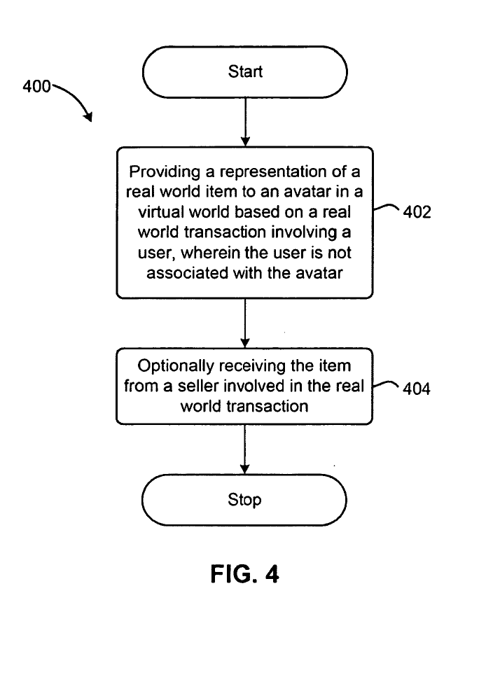

FIG. 4 illustrates a flow chart of a method 400 according to one embodiment. As an option, the present method 400 may be implemented in the context and functionality of a computer or computer system. Of course, the method 400 may be carried out in any desired environment. It should be noted that the aforementioned definitions may apply during the present description.

With continued reference to FIG. 4, in operation 402, a representation of a real world item is provided to an avatar in a virtual world based on a real world transaction involving a user, wherein the user is not associated with the avatar.

In optional operation 404, the item may be received from a seller involved in the real world transaction. Of course, the item may also come from some other source besides the seller of the item in the real world transaction.

It will be clear that the various features of the foregoing methodologies may be combined in any way, creating a plurality of combinations from the descriptions presented above.

It will also be clear to one skilled in the art that the methodology of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
providing access to a representation of a real world item to an avatar in a virtual world based on a real world transaction involving a user associated with the avatar.

2. The method of claim 1, wherein the real world transaction is a retail purchase of the real world item.

3. The method of claim 2, wherein a receipt of the retail purchase includes a code for accessing the representation of the real world item in the virtual world, and further comprising receiving the code from the user.

4. The method of claim 2, further comprising receiving the representation of the real world item from a seller of the real world item.

5. The method of claim 1, wherein the avatar acts as a virtual shopping assistant to the user.

6. The method of claim 1, wherein the real world transaction is a retail purchase of an item, wherein the representation is of a real world item having a predefined association with the purchased item.

7. The method of claim 1, wherein the real world transaction is receipt of a code by a portable device, the code being associated with the representation of the real world item.

8. The method of claim 1, wherein access to the representation of the real world item in the virtual world is provided for a fee.

9. The method of claim 1, wherein access to the representation of the real world item in the virtual world expires after a predetermined amount of time.

10. The method of claim 1, wherein the real world transaction is receipt of a request from the user to access the representation of the real world item

11. A method, comprising:
receiving notice that a user has purchased a real world item;
providing access to a representation of the real world item to an avatar in a virtual world; and
allowing the avatar to interact with the representation of the real world item in the virtual world;
outputting.

12. The method of claim 11, wherein a receipt of the retail purchase includes a code for accessing the representation of the real world item in the virtual world, and further comprising receiving the code from the user.

13. The method of claim 11, further comprising receiving the representation of the real world item from a seller of the real world item.

14. The method of claim 11, wherein the avatar acts as a virtual shopping assistant to the user.

15. The method of claim 11, further comprising providing access to a representation of another item having a predefined association with the purchased item.

16. The method of claim 15, wherein the other item does not exist in the real world.

17. The method of claim 15, wherein the other item exists in the real world and is for sale by a seller of the real world item purchased by the user.

18. A method, comprising:
providing an item to an avatar in a virtual world based on a real world transaction involving a user associated with the avatar.

19. The method of claim 18, wherein the item does not exist in the real world.

20. A method, comprising:
providing a representation of a real world item to an avatar in a virtual world based on a real world transaction involving a user,
wherein the user is not associated with the avatar.
